(19) United States
(12) Patent Application Publication
(10) Pub. No.: US 2026/0093449 A1
(43) Pub. Date: Apr. 2, 2026

(54) AUDIO DESCRIPTION OF PHYSICAL OBJECTS

(71) Applicant: Apple Inc., Cupertino, CA (US)

(72) Inventor: Anshu Chimalamarri, Sunnyvale, CA (US)

(21) Appl. No.: 19/336,030

(22) Filed: Sep. 22, 2025

Related U.S. Application Data
(60) Provisional application No. 63/700,441, filed on Sep. 27, 2024.

(51) Int. Cl. G06F 3/16; G06F 3/01; G06V 30/10

(52) U.S. Cl. CPC G06F 3/167; G06F 3/013; G06F 3/017; G06V 30/10

(57) ABSTRACT

In one implementation, a method of playing a sound is performed by a first device having an image sensor, one or more processors, and non-transitory memory. The method includes capturing, using the image sensor, an image of a physical environment including a physical object. The method includes determining that one or more description criteria are satisfied, wherein the description criteria includes a criterion that is satisfied when the first device detects that a gaze of the user is directed at the physical object. The method includes, in response to determining that the description criteria are satisfied, playing a sound describing the physical object.

### CROSS-REFERENCE TO RELATED APPLICATIONS

This application claims priority to U.S. Provisional Patent App. No. 63/700,441, filed on Sep. 27, 2024, which is incorporated by reference in its entirety.

### TECHNICAL FIELD

The present disclosure generally relates to systems, methods, and devices of providing an audio description of physical objects.

### BACKGROUND

Visually impaired people may have difficulty determining the identity or status of a physical object.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-2E illustrate a first XR environment during various time periods in accordance with some implementations.

FIGS. 3A-3C illustrate a second XR environment during various time periods in accordance with some implementations.

FIGS. 4A-4C illustrate a third XR environment during various time periods in accordance with some implementations.

FIG. 5 is a flowchart representation of a method of playing a sound in accordance with some implementations.

FIG. 6 is a block diagram of an example controller in accordance with some implementations.

FIG. 7 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for playing a sound. In various implementations, the method is performed by a first device having an image sensor, one or more processors, and non-transitory memory. The method includes capturing, using the image sensor, an image of a physical environment including a physical object. The method includes determining that one or more description criteria are satisfied, wherein the description criteria includes a criterion that is satisfied when the first device detects that a gaze of the user is directed at the physical object. The method includes, in response to determining that the description criteria are satisfied, playing a sound describing the physical object.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, visually impaired people may have difficulty determining the identity or status of a physical object. Accordingly, in various implementations, a device, such as a head-mounted device, includes a camera to capture an image of a physical environment including an object, a processor to determine a description of the object, and a speaker to play audio describing the object. In various implementations, the device includes an eye tracker that determines a gaze of a user and the device plays audio describing the object that the user is looking at. In various implementations, the device only plays audio describing the object that the user is looking at when particular description criteria are satisfied. For example, the criteria can include a criterion that is satisfied when the user requests a description (using a vocal gesture or a hand gesture). As another example, the criteria can include a criterion that is satisfied when the object has a particular object type or is near other similar looking objects.

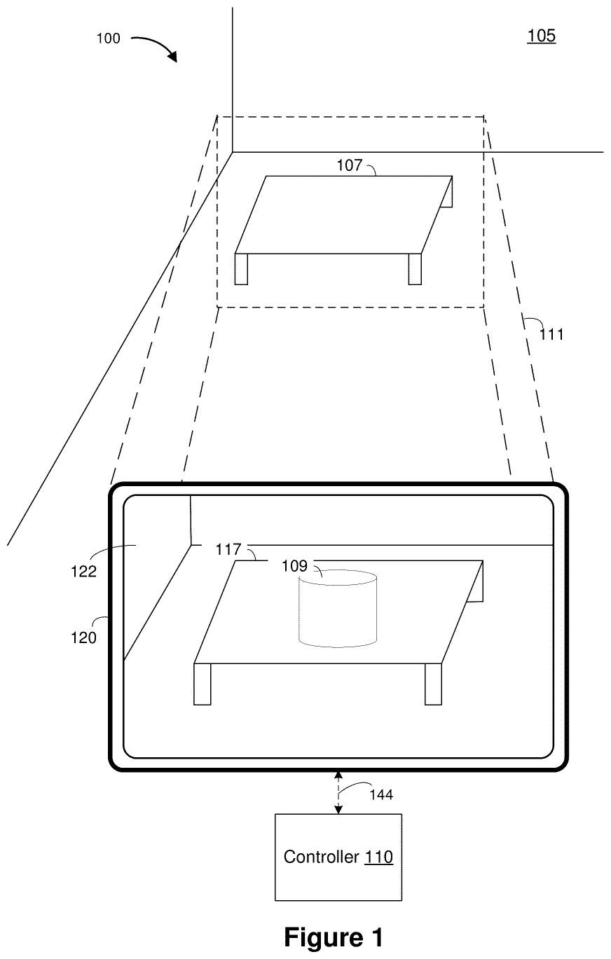

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

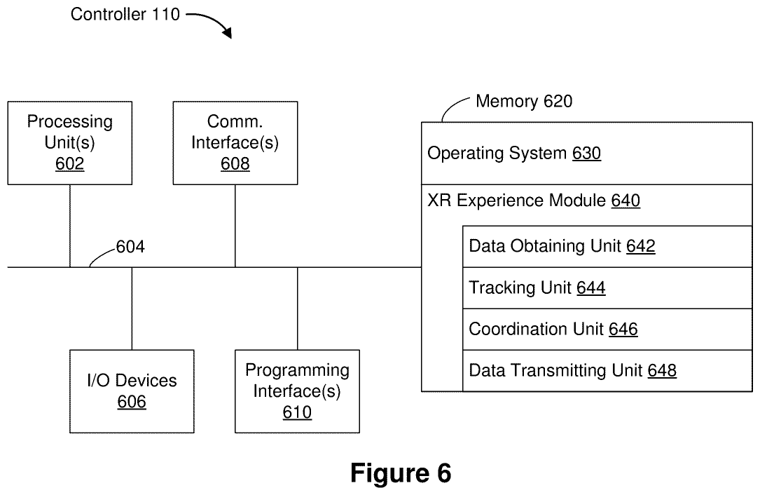

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 6. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

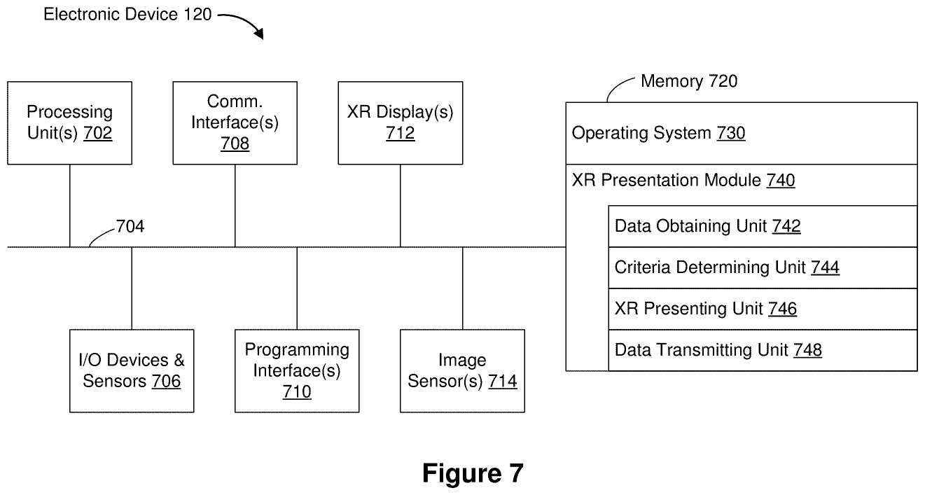

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 7.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

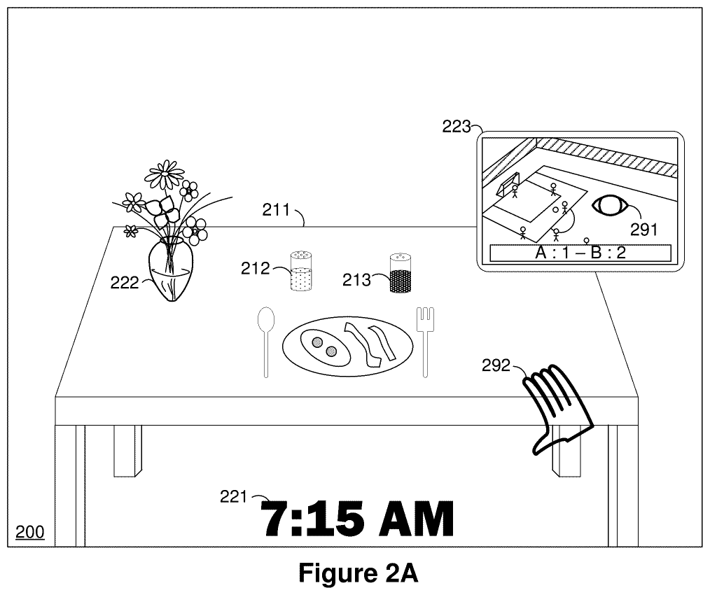

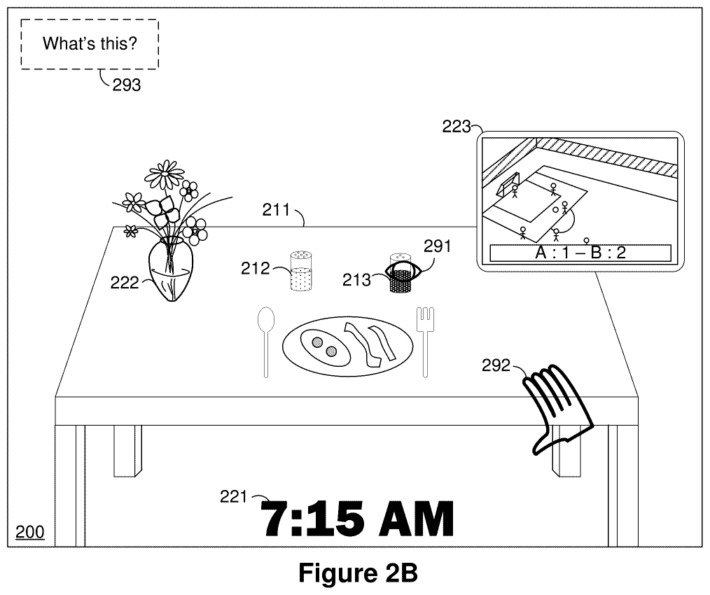

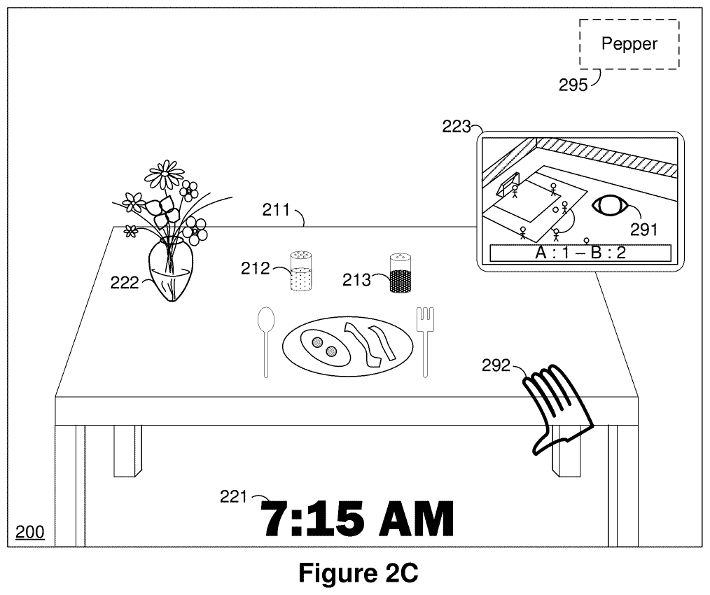

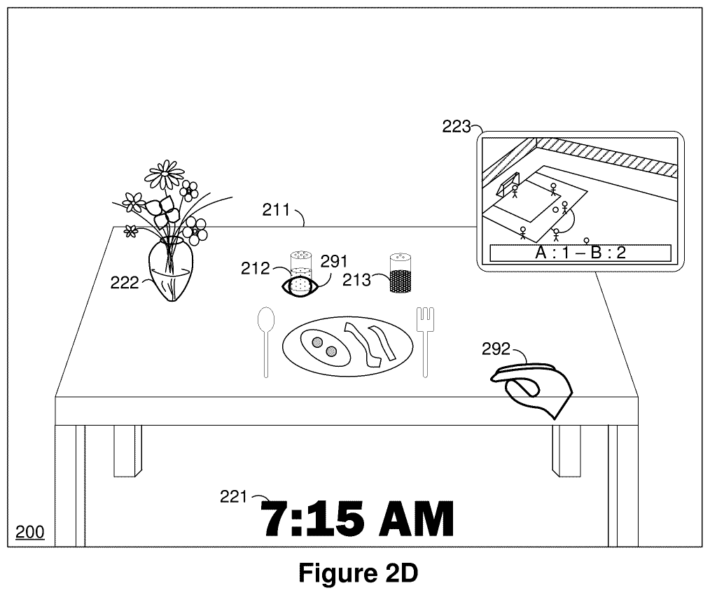

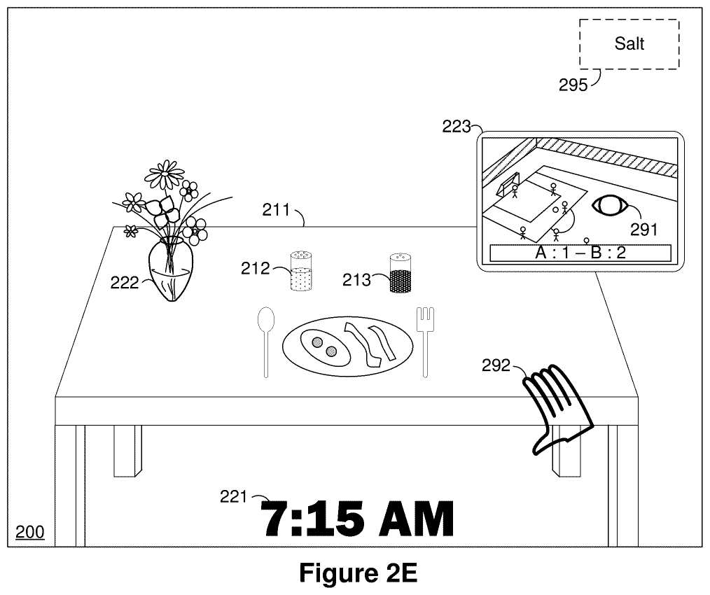

FIGS. 2A-2E illustrate a first XR environment 200 based on a physical environment of a dining room from the perspective of a user of an electronic device displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the first XR environment 200. For ease of illustration, FIGS. 2A-2E illustrate the first XR environment 200 as presented on a single one of the multiple displays.

In various implementations, the perspective of the user is from a location of an image sensor of the electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user if the head-mounted electronic device were not present. In various implementations, the perspective of the user is from the location of an avatar of the user. For example, in various implementations, the first XR environment 200 is a virtual environment and the perspective of the user is from the location of an avatar or other representation of the user directed towards the virtual environment.

FIGS. 2A-2E illustrate the first XR environment 200 during a series of time periods. In various implementations, each time period is an instant, a fraction of a second, a few seconds, a few hours, a few days, or any length of time.

The first XR environment 200 includes a plurality of objects, including one or more real objects (e.g., a table 211, a salt shaker 212, a pepper shaker 213, and a hand 292) and one or more virtual objects (e.g., a virtual clock 221, virtual flowers 222, and a virtual screen 223). In various implementations, certain objects (such as the real objects, the virtual flowers 222, and the virtual screen 223) are presented at a location in the first XR environment 200, e.g., at a location defined by three coordinates in a three-dimensional (3D) XR coordinate system. Accordingly, when the electronic device moves in the first XR environment 200 (e.g., changes cither position and/or orientation), the objects are moved on the display of the electronic device, but retain their (possibly time-dependent) location in the first XR environment 200. Such virtual objects that, in response to motion of the electronic device, move on the display, but retain their position in the first XR environment 200 are referred to as world-locked objects. In various implementations, certain virtual objects (such as the virtual clock 221) are displayed at locations on the display such that when the electronic device moves in the first XR environment 200, the objects are stationary on the display on the electronic device. Such virtual objects that, in response to motion of the electronic device, retain their location on the display are referred to as head-locked objects or display-locked objects.

FIGS. 2A-2E illustrate a gaze location indicator 291 that indicates a gaze location of the user, e.g., where in the first XR environment 200 the user is looking. Although the gaze location indicator 291 is illustrated in FIGS. 2A-2E, in various implementations, the gaze location indicator 291 is not displayed by the electronic device.

During the first time period, the user is looking at the virtual screen 223 (as indicated by the gaze location indicator 291) and the hand 292 is in a neutral position.

FIG. 2B illustrates the first XR environment 200 during a second time period subsequent to the first time period. During the second time period, the user is looking at the pepper shaker 213 (as indicated by the gaze location indicator 291) and the hand 292 is in a neutral position. Also during the second time period, the user verbally requests a description of an object. FIG. 2B illustrates the speech of the user detected by the electronic device in speech detection box 293 (e.g., “What's this?”). Although the speech detection box 293 is illustrated in the first XR environment 200 as a display-locked object, in various implementations, the speech detection box 293 is not displayed.

FIG. 2C illustrates the first XR environment 200 during a third time period subsequent to the second time period. During the third time period, in response to detecting the user looking at the pepper shaker 213 and verbally requesting an object description, the electronic device plays speech describing the pepper shaker 213. FIG. 2C illustrates the speech produced by the electronic device in a speech production box 295 (e.g., “Pepper”). Although the speech production box 295 is illustrated in the first XR environment 200 as a display-locked object, in various implementations, the speech production box 295 is not displayed. During the third time period, the user is looking at the virtual screen 223 (as indicated by the gaze location indicator 291) and the hand 292 is in a neutral position.

FIG. 2D illustrates the first XR environment 200 during a fourth time period subsequent to the third time period. During the fourth time period, the user is looking at the salt shaker 212 (as indicated by the gaze location indicator 291) and the hand 292 is performing a gesture corresponding to a request for a description of an object. FIG. 2D illustrates a talking gesture as example gesture corresponding to the request in which the fingers of the hand 292 are held straight while the thumb of the hand 292 taps the middle of the ring and/or middle finger one or more times (e.g., the gesture one makes when using a puppet or while saying “blah blah blah”). Any suitable gesture may be assigned as the gesture corresponding to the request. Preferably, the gesture corresponding to the request differs from other gestures, such as a gesture to select a user interface element (e.g., a pinch gesture in which the thumb and index finger at tapped together).

FIG. 2E illustrates the first XR environment 200 during a fifth time period subsequent to the fourth time period. During the fifth time period, in response to detecting the user looking at the salt shaker 212 and performing the gesture corresponding to a request for an object description, the electronic device plays speech describing the salt shaker 212. FIG. 2E illustrates the speech produced by the electronic device in the speech production box 295 (e.g., “Salt”).

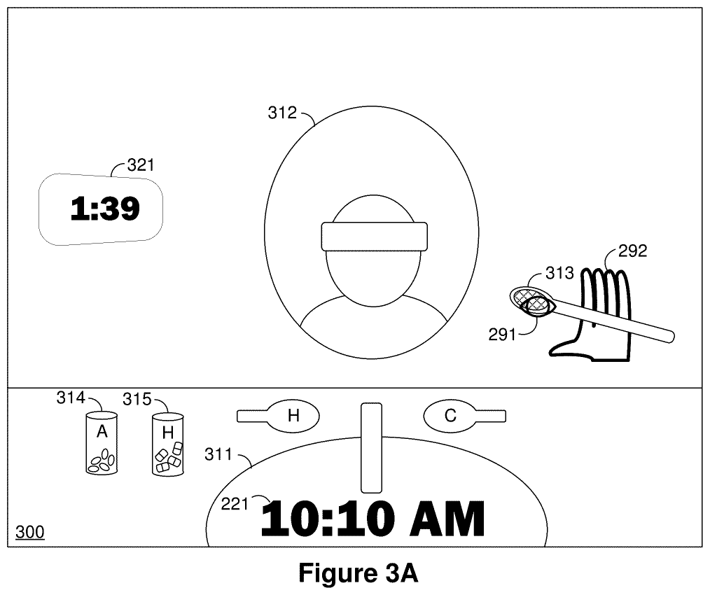

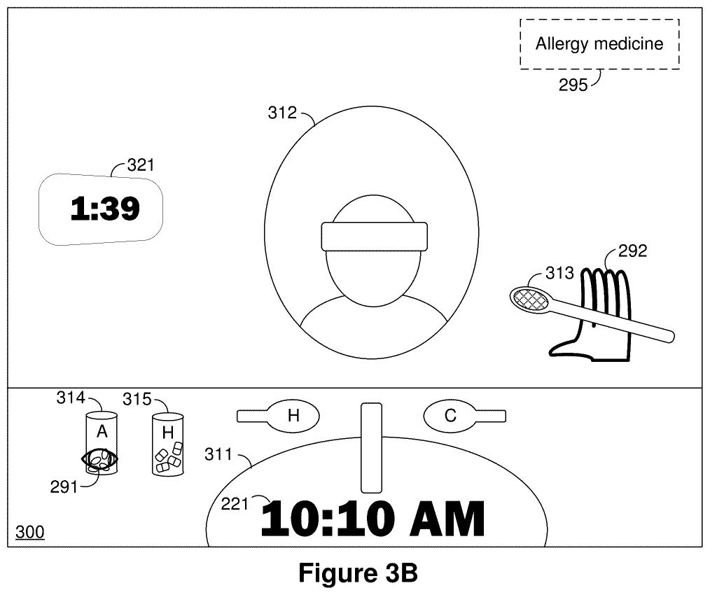

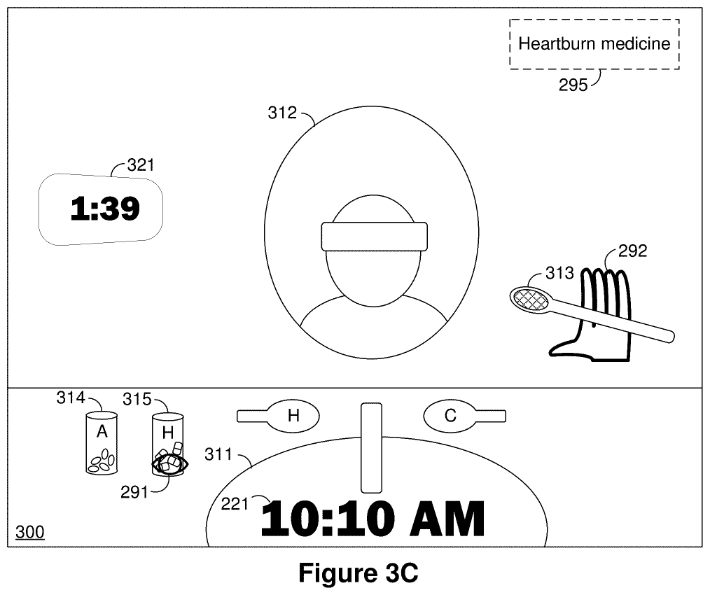

FIGS. 3A-3C illustrate a second XR environment 300 based on a physical environment of a bathroom from the perspective of the user of an electronic device displayed, at least in part, by a display of the electronic device. FIGS. 3A-3C illustrate the second XR environment 300 during a series of time periods. FIGS. 3A-3C illustrate the gaze location indicator 291 that indicates a gaze location of the user, e.g., where in the second XR environment 300 the user is looking.

The second XR environment 300 includes a plurality of objects, including one or more real objects (e.g., a sink 311, a mirror 312, a toothbrush 313, a bottle of allergy medicine 314, a bottle of heartburn medicine 315, and the hand 292) and one or more virtual objects (e.g., the virtual clock 221 and a virtual timer 321). In various implementations, certain objects (such as the real objects and the virtual timer 321) are world-locked objects. In various implementations, certain virtual objects (such as the virtual clock 221) are display-locked objects.

FIG. 3A illustrates the second XR environment 300 during a first time period. During the first time period, the user is looking at the toothbrush 313 (as indicated by the gaze location indicator 291) and the hand 292 is holding the toothbrush 313.

FIG. 3B illustrates the second XR environment 300 during a second time period subsequent to the first time period. During the second time period, the user is looking at the bottle of allergy medicine 314 (as indicated by the gaze location indicator 291). In response to detecting the user looking at the bottle of allergy medicine 314 and determining that an audio description setting for medicine is active, the electronic device plays speech describing the bottle of allergy medicine 314. Thus, in response to determining that the user is looking at an object that has an object type of “medicine” (and an audio description setting to describe objects having an object type of “medicine” when a user looks at the object is active), the electronic device plays speech describing the object. FIG. 3B illustrates the speech produced by the electronic device in the speech production box 295 (e.g., “Allergy medicine”).

FIG. 3C illustrates the second XR environment 300 during a third time period subsequent to the second time period. During the third time period, the user is looking at the bottle of heartburn medicine 315 (as indicated by the gaze location indicator 291). In response to detecting the user looking at the bottle of heartburn medicine 315, detecting the bottle of allergy medicine 314, and determining that an audio description setting for similar object is active, the electronic device plays speech describing the bottle of heartburn medicine 315. Thus, in response to determining that the user is looking at an object that is near (e.g., within the same field-of-view as) one or more similar looking objects (and an audio description setting to describe objects near similar looking objects when a user looks at the object is active), the electronic device plays speech describing the object. FIG. 3C illustrates the speech produced by the electronic device in the speech production box 295 (e.g., “Heartburn medicine”).

A user may interact with the electronic device to activate or deactivate an audio description setting for various object types, such as medicine, canned goods, books, currency. Similarly, a user may interact with the electronic device to activate or deactivate an audio description setting for various contexts, such as when two or more similar looking objects are close together or when text below a threshold size is detected.

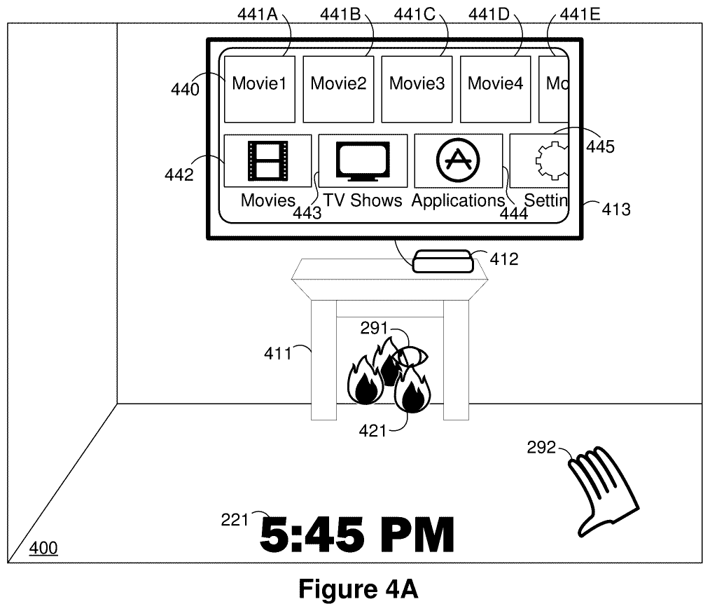

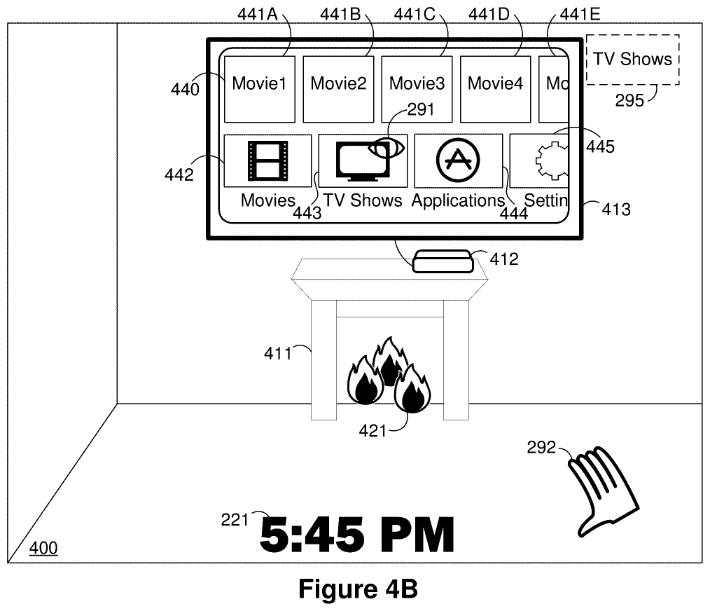

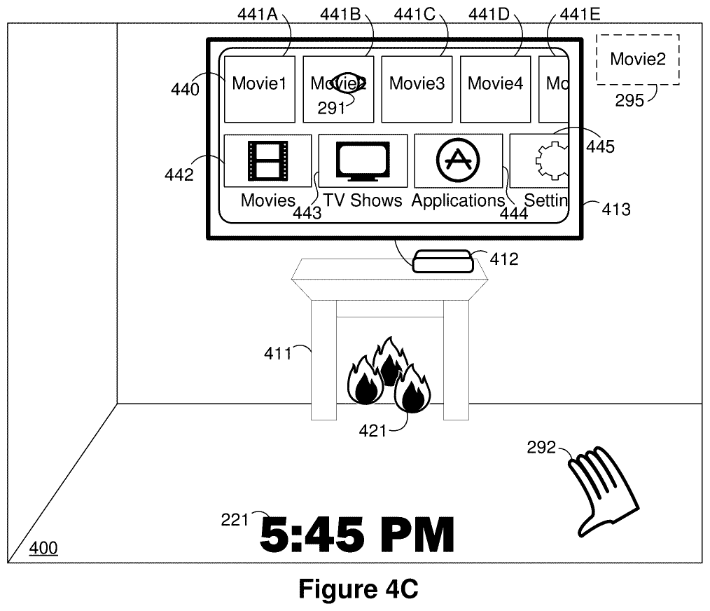

FIGS. 4A-4C illustrate a third XR environment 400 based on a physical environment of a living room from the perspective of the user of an electronic device displayed, at least in part, by a display of the electronic device. FIGS. 4A-4C illustrate the third XR environment 400 during a series of time periods. FIGS. 4A-4C illustrate the gaze location indicator 291 that indicates a gaze location of the user, e.g., where in the third XR environment 400 the user is looking.

The third XR environment 400 includes a plurality of objects, including one or more real objects (e.g., a fireplace 411, a digital media player (DMP) 412, a television 413, and the hand 292) and one or more virtual objects (e.g., the virtual clock 221 and a virtual fire 421). In various implementations, certain objects (such as the real objects and the virtual fire 421) are world-locked objects. In various implementations, certain virtual objects (such as the virtual clock 221) are display-locked objects.

In FIGS. 4A-4C, the television 413 displays a graphical user interface (GUI) 440 generated by the DMP 412. The GUI 440 includes a number of user interface elements, including a plurality of movie affordances 441A-441E for playing respective movies, a movies affordance 442 for displaying a plurality of movies for selection, a television shows affordance 443 for displaying a plurality of television shows for selection, an applications affordance 444 for displaying a plurality of applications for selection, and a settings affordance 445 for changing settings of the DMP 412.

FIG. 4A illustrates the third XR environment 400 during a first time period. During the first time period, the user is looking at the virtual fire 421 (as indicated by the gaze location indicator 291) and the hand 292 is in a neutral position.

FIG. 4B illustrates the third XR environment 400 during a second time period subsequent to the first time period. During the second time period, the user is looking at a television shows affordance 443 (as indicated by the gaze location indicator 291). In response to detecting the user looking at the television shows affordance 443 and determining that an audio description setting for the DMP 412 is active, the electronic device plays speech describing the television shows affordance 443. FIG. 4B illustrates the speech produced by the electronic device in the speech production box 295 (e.g., “Television Shows”).

In various implementations, the electronic device generates the speech by detecting the icon of the television shows affordance 443 in an image of the physical environment. In various implementations, the electronic device generates the speech by detecting (and decoding) the text of the television shows affordance 443.

FIG. 4C illustrates the third XR environment 400 during a third time period subsequent to the second time period. During the third time period, the user is looking at a second movie affordance 441B of the plurality of movie affordances 441A-441E (as indicated by the gaze location indicator 291). In response to detecting the user looking at the second movie affordance 441B and determining that the audio description setting for the DMP 412 is active, the electronic device plays speech describing the second movie affordance 441B. FIG. 4C illustrates the speech produced by the electronic device in the speech production box 295 (e.g., “Movie2”).

In various implementations, the electronic device generates the speech by transmitting gaze information to the DMP 412 and receiving a description of the user interface element the user is looking at from the DMP 412. For example, the electronic device detects the GUI 440 displayed by the television 413 and determines that the user's gaze location is a third of the way from the left edge to the right edge and a fifth of the way from the top edge to the bottom edge. The electronic device may transmit this information to the DMP 412 as a vector having two elements ranging from zero to one. Based on the gaze information, the DMP 412 determines the user interface element the user is looking at and transmits a description of the user interface element to the electronic device.

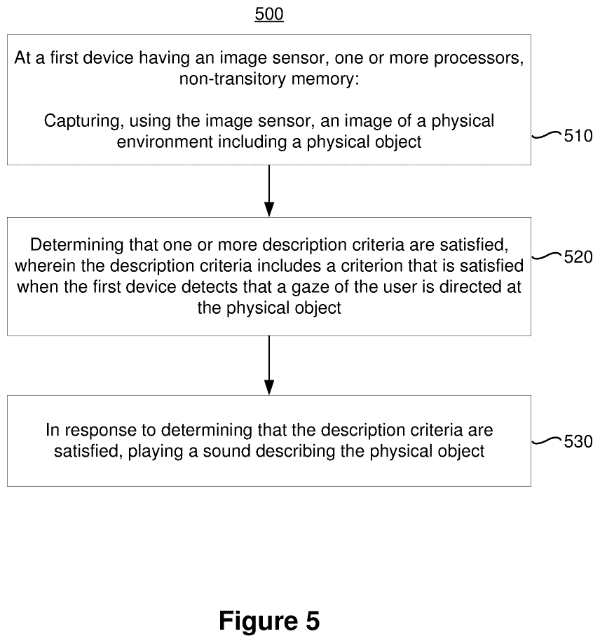

FIG. 5 is a flowchart representation of a method 500 of playing a sound describing a physical object in accordance with some implementations. In various implementations, the method 500 is performed by an electronic device, such as the electronic device 120 of FIG. 1. In various implementations, the method 500 is performed by a first device having an image sensor, one or more processors, and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the first device capturing, using the image sensor, an image of a physical environment including a physical object. In various implementations, the physical object is a smart device including wireless communication capabilities.

The method 500 continues, in block 520, with the first device determining that one or more description criteria are satisfied, wherein the description criteria includes a criterion that is satisfied when the first device detects that a gaze of the user is directed at the physical object.

The method 500 continues, in block 530, with the first device, in response to determining that the description criteria are satisfied, playing a sound describing the physical object.

In various implementations, the description criteria includes a criterion that is satisfied when the first device detects that the user has issued a vocal command. For example, in FIG. 2B, the electronic device detects the user issuing a vocal command of “What's this?” and, in response, as shown in FIG. 2C, the electronic device plays a sound describing the object the user is looking at, e.g., the pepper shaker 213.

In various implementations, the description criteria includes a criterion that is satisfied when the first device detects that the user has performed a predefined hand gesture. For example, in FIG. 2D, the electronic device detects the user performing the talking gesture and, in response, as shown in FIG. 2E, the electronic device plays a sound describing the object the user is looking at, e.g., the salt shaker 212.

In various implementations, the description criteria includes a criterion that is satisfied when the first device detects that an audio description setting is active. In various implementations, when the audio description setting for a particular object type is active, the first device plays a sound describing a physical object of the particular object type when a user looks at the physical object of the particular object type. Thus, in various implementations, the description criteria includes a criterion that is satisfied when the first device determines that the physical object has a particular object type. For example, in FIG. 3B, in response to determining that the user is looking at the bottle of allergy medicine 314, the electronic device plays a sound describing the bottle of allergy medicine 314. The sound describing the physical object of the particular object type may indicate the particular object type or include additional information such as a subtype. For example, in FIG. 3B, the particular object type is “medicine” and the subtype is “allergy medicine.”

In various implementations, when the audio description setting for a particular context is active, the first device plays a sound describing the physical object a user is looking at when the context is detected. For example, the context may include the detection of multiple object having a similar look, e.g., a similar size, shape, color, pattern, and/or texture. Thus, in various implementations, the description criteria includes a criterion that is satisfied when the first device detects one or more additional physical objects satisfying a similarity threshold with the physical object. For example, in FIG. 3C, in response to determining that the user is looking at the bottle of heartburn medicine 315 while detecting the similar-looking bottle of allergy medicine 314, the electronic device plays a sound describing the bottle of heartburn medicine 315. As another example, in various implementations, in response to detecting multiple currency bills, the first device describes the denomination of the bill the user is looking at. As another example, in various implementations, in response to detecting multiple canned goods, the first device describes the contents of the can the user is looking at. As another example, in various implementations, in response to detecting multiple books, the first device describes the title of the book the user is looking at.

As another example, the context may include the detection of text on the physical object having a size less than a size threshold. Thus, in various implementations, the description criteria includes a criterion that is satisfied when the first device detects text having a size below a size threshold on the physical object. In various implementations, the size threshold is set by a user. In various implementations, the size threshold is based on a biometric of the user stored by the first device. For example, in various implementations, the user's vision prescription is known by the first device (and, in some embodiments, corresponds to the shape of one or more lenses of the device) and the first device bases the size threshold on the prescription.

In various implementations, the physical object is a user interface element of a second device separate from the first device. Specifically, the physical object is a portion of a physical display (e.g., a screen) displaying a graphical user interface including the user interface element in the portion. For example, in FIG. 4B, in response to detecting the user looking at the television shows affordance 443, the electronic device plays a sound describing the television shows affordance 443. In various implementations, the description criteria includes a criterion that is satisfied when the user interface element has focus. For a digital media player, the focus may be indicated by enlarging the user interface element with focus. For a laptop computer, the focus may be indicated by displaying a cursor at the location of the focus.

In various implementations, the method 500 further includes receiving, from the second device, a description of the user interface element, wherein playing the sound is based on the description of the user interface element. The description of the user interface element may be received from the second device in response to a query transmitted by the first device. In various implementations, the second device determines the user interface element the user is looking at. For example, a smartphone with a front-facing camera may be able to determine the user interface element that the user is looking at and provide a description to the first device in response to a query. In various implementations, the query from the first device includes gaze information. Thus, in various implementations, the method 500 further includes transmitting gaze information to the second device. In various implementations, the gaze information indicates a gaze location in a coordinate system of the second device (e.g., the coordinate system of the display upon which the user interface element is displayed). In various implementations, the gaze information indicates a gaze location in a coordinate system of the first device and the second device converts the gaze location to the gaze location in the coordinate system of the second device based on pose information of the first device (which may be transmitted as part of the query or determined by the second device using a front-facing camera).

As noted above, in various implementations, the first device generates the sound based on information received from a second device. In various implementations, the first device generates the sound based on image processing of the image of the physical environment. For example, in various implementations, playing the sound describing the physical object is based on semantic identification of the physical object in the image of the physical environment. As another example, in various implementations, playing the sound describing the object is based on optical character recognition of text on the physical object in the image of the physical environment.

In various implementations, playing the sound also includes displaying text describing the sound. In various implementations, the displayed text is display-locked object. In various implementations, the displayed text is world-locked object displayed at a location in the physical environment of the physical object. In various implementations, playing the sound does not include displaying text. However, in various implementations, playing the sound includes playing the sound spatially from a location of the physical object in the physical environment. In various implementations, the sound is spatialized to play from the location in the physical environment using binaural rendering in which a source signal is filtered with two head-related transfer functions (HRTFs) that are based on the relative position of the head of the user and the location in the physical environment (e.g., determined using head tracking) and the resultant signals are played by two speakers respectively proximate to the two cars of the user.

In various implementations, the sound describing the object indicates an identity (or object type) of the object. In various implementations, as noted above, the sound describing the object indicates an object sub-type of the object. In various implementations, the sound describing the object indicates the contents of the object. For example, in FIG. 2C, the electronic device indicates that the pepper shaker 213 contains pepper. In various implementations, the sound describing the object indicates a status of an object. For example, the electronic device may indicate that a coffee-maker is on or off or indicate a volume setting of television.

FIG. 6 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 602 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 606, one or more communication interfaces 608 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 610, a memory 620, and one or more communication buses 604 for interconnecting these and various other components.

In some implementations, the one or more communication buses 604 include circuitry that interconnects and controls communications between system components. In some implementations, the one or more I/O devices 606 include at least one of a keyboard, a mouse, a touchpad, a joystick, one or more microphones, one or more speakers, one or more image sensors, one or more displays, and/or the like.

The memory 620 includes high-speed random-access memory, such as dynamic random-access memory (DRAM), static random-access memory (SRAM), double-data-rate random-access memory (DDR RAM), or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR experience module 640.

The operating system 630 includes procedures for handling various basic system services and for performing hardware dependent tasks. In some implementations, the XR experience module 640 is configured to manage and coordinate one or more XR experiences for one or more users (e.g., a single XR experience for one or more users, or multiple XR experiences for respective groups of one or more users). To that end, in various implementations, the XR experience module 640 includes a data obtaining unit 642, a tracking unit 644, a coordination unit 646, and a data transmitting unit 648.

In some implementations, the data obtaining unit 642 is configured to obtain data (e.g., presentation data, interaction data, sensor data, location data, etc.) from at least the electronic device 120 of FIG. 1. To that end, in various implementations, the data obtaining unit 642 includes instructions and/or logic therefor, and heuristics and metadata therefor.

In some implementations, the tracking unit 644 is configured to map the physical environment 105 and to track the position/location of at least the electronic device 120 with respect to the physical environment 105 of FIG. 1. To that end, in various implementations, the tracking unit 644 includes instructions and/or logic therefor, and heuristics and metadata therefor.

In some implementations, the coordination unit 646 is configured to manage and coordinate the XR experience presented to the user by the electronic device 120. To that end, in various implementations, the coordination unit 646 includes instructions and/or logic therefor, and heuristics and metadata therefor.

In some implementations, the data transmitting unit 648 is configured to transmit data (e.g., presentation data, location data, etc.) to at least the electronic device 120. To that end, in various implementations, the data transmitting unit 648 includes instructions and/or logic therefor, and heuristics and metadata therefor.

Although the data obtaining unit 642, the tracking unit 644, the coordination unit 646, and the data transmitting unit 648 are shown as residing on a single device (e.g., the controller 110), it should be understood that in other implementations, any combination of the data obtaining unit 642, the tracking unit 644, the coordination unit 646, and the data transmitting unit 648 may be located in separate computing devices.

Moreover, FIG. 6 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 7 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 710, one or more XR displays 712, one or more optional interior- and/or exterior-facing image sensors 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 712 are configured to provide the XR experience to the user. In some implementations, the one or more XR displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 712 correspond to diffractive, reflective, polarized, holographic, etc. waveguide displays. For example, the electronic device 120 includes a single XR display. In another example, the electronic device includes an XR display for each eye of the user. In some implementations, the one or more XR displays 712 are capable of presenting MR and VR content.

In some implementations, the one or more image sensors 714 are configured to obtain image data that corresponds to at least a portion of the face of the user that includes the eyes of the user (any may be referred to as an eye-tracking camera). In some implementations, the one or more image sensors 714 are configured to be forward-facing so as to obtain image data that corresponds to the physical environment as would be viewed by the user if the electronic device 120 was not present (and may be referred to as a scene camera). The one or more optional image sensors 714 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium. In some implementations, the memory 720 or the non-transitory computer readable storage medium of the memory 720 stores the following programs, modules and data structures, or a subset thereof including an optional operating system 730 and an XR presentation module 740.

The operating system 730 includes procedures for handling various basic system services and for performing hardware dependent tasks. In some implementations, the XR presentation module 740 is configured to present XR content to the user via the one or more XR displays 712. To that end, in various implementations, the XR presentation module 740 includes a data obtaining unit 742, a criteria determining unit 744, an XR presenting unit 746, and a data transmitting unit 748.

In some implementations, the data obtaining unit 742 is configured to obtain data (e.g., presentation data, interaction data, sensor data, location data, etc.) from at least the controller 110 of FIG. 1. To that end, in various implementations, the data obtaining unit 742 includes instructions and/or logic therefor, and heuristics and metadata therefor.

In some implementations, the criteria determining unit 744 is configured to determining whether one or more description criteria are satisfied. To that end, in various implementations, the status determining unit 744 includes instructions and/or logic therefor, and heuristics and metadata therefor.

In some implementations, the XR presenting unit 746 is configured to, in response to determining that the description criteria are satisfied, play a sound describing a physical object a user is looking at. To that end, in various implementations, the XR presenting unit 746 includes instructions and/or logic therefor, and heuristics and metadata therefor.

In some implementations, the data transmitting unit 748 is configured to transmit data (e.g., presentation data, location data, etc.) to at least the controller 110. In some implementations, the data transmitting unit 748 is configured to transmit authentication credentials to the electronic device. To that end, in various implementations, the data transmitting unit 748 includes instructions and/or logic therefor, and heuristics and metadata therefor.

Although the data obtaining unit 742, the criteria determining unit 744, the XR presenting unit 746, and the data transmitting unit 748 are shown as residing on a single device (e.g., the electronic device 120), it should be understood that in other implementations, any combination of the data obtaining unit 742, the criteria determining unit 744, the XR presenting unit 746, and the data transmitting unit 748 may be located in separate computing devices.

Moreover, FIG. 7 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a first device having an image sensor, one or more processors, and non-transitory memory;
capturing, using the image sensor, an image of a physical environment including a physical object;
determining that one or more description criteria are satisfied, wherein the description criteria includes a criterion that is satisfied when the first device detects that a gaze of a user is directed at the physical object; and
in response to determining that the description criteria are satisfied, playing a sound describing the physical object.

2. The method of claim 1, wherein the description criteria includes a criterion that is satisfied when the first device detects that the user has issued a vocal command.

3. The method of claim 1, wherein the description criteria includes a criterion that is satisfied when the first device detects that the user has performed a predefined hand gesture.

4. The method of claim 1, wherein the description criteria includes a criterion that is satisfied when the first device detects that an audio description setting is active.

5. The method of claim 1, wherein the description criteria includes a criterion that is satisfied when the first device determines that the physical object has a particular object type.

6. The method of claim 1, wherein the description criteria includes a criterion that is satisfied when the first device detects one or more additional physical objects satisfying a similarity threshold with the physical object.

7. The method of claim 1, wherein the description criteria includes a criterion that is satisfied when the first device detects text having a size below a size threshold on the physical object.

8. The method of claim 1, wherein the physical object is a user interface element of a second device separate from the first device.

9. The method of claim 8, wherein the description criteria includes a criterion that is satisfied when the user interface element has focus.

10. The method of claim 8, further comprising receiving, from the second device, a description of the user interface element, wherein playing the sound is based on the description of the user interface element.

11. The method of claim 10, further comprising transmitting gaze information to the second device.

12. The method of claim 1, wherein playing the sound describing the physical object is based on semantic identification of the physical object in the image of the physical environment.

13. The method of claim 1, wherein playing the sound describing the physical object is based on optical character recognition of text on the physical object in the image of the physical environment.

14. The method of claim 1, wherein playing the sound includes playing the sound spatially from a location of the physical object in the physical environment.

15. A first device comprising:
an image sensor;
a non-transitory memory; and
one or more processors to:
capture, using the image sensor, an image of a physical environment including a physical object;
determine that one or more description criteria are satisfied, wherein the description criteria includes a criterion that is satisfied when the first device detects that a gaze of a user is directed at the physical object; and
in response to determining that the description criteria are satisfied, play a sound describing the physical object.

16. The first device of claim 15, wherein the description criteria includes a criterion that is satisfied when the first device detects one or more additional physical objects satisfying a similarity threshold with the physical object.

17. The first device of claim 15, wherein the description criteria includes a criterion that is satisfied when the first device detects text having a size below a size threshold on the physical object.

18. The first device of claim 15, wherein the physical object is a user interface element of a second device separate from the first device, wherein the one or more processors are further to receive, from the second device, a description of the user interface element and to play the sound based on the description of the user interface element.

19. The first device of claim 15, wherein the one or more processors are to play the sound spatially from a location of the physical object in the physical environment.

20. A non-transitory memory storing one or more programs, which, when executed by one or more processors of a first device including an image sensor, cause the device to:
capture, using the image sensor, an image of a physical environment including a physical object;
determine that one or more description criteria are satisfied, wherein the description criteria includes a criterion that is satisfied when the first device detects that a gaze of a user is directed at the physical object; and
in response to determining that the description criteria are satisfied, play a sound describing the physical object.
